(19) United States
(12) Patent Application Publication
(10) Pub. No.: US 2013/0018611 A1
(43) Pub. Date: Jan. 17, 2013

(54) Systems and Methods of Measuring Gap Height

(71) Applicant: Ryan A. Sturmer, Durham, NC (US)

(72) Inventor: Ryan A. Sturmer, Durham, NC (US)

(73) Assignee: ADVANCED LIQUID LOGIC INC, Research Triangle Park, NC (US)

(21) Appl. No.: 13/545,716

(22) Filed: Jul. 10, 2012

Related U.S. Application Data
(60) Provisional application No. 61/506,631, filed on Jul. 11, 2011.

(51) Int. Cl. G06F 19/00

(52) U.S. Cl. 702/65

(57) ABSTRACT

A method of determining a gap height in a droplet actuator including measuring an impedance between a droplet operations electrode of a first substrate in a droplet actuator and ground electrode of a second substrate in the droplet actuator, storing a lookup table that associates impedances to heights of gaps between the first substrate and the second substrate, querying the lookup table for the impedance measured between the droplet operations electrode of the first substrate and the ground electrode of the second substrate; and retrieving a height of a gap associated with the impedance.

### 1 RELATED APPLICATION

This application claims the priority of U.S. Provisional Patent Application Ser. No. 61/506,631, filed Jul. 11, 2011, the disclosure of which is incorporated by reference in its entirety.

### 2 FIELD OF THE INVENTION

The invention provides systems and methods of determining gap height in a droplet actuator.

3 BACKGROUND OF THE INVENTION

A droplet actuator typically includes one or more substrates configured to form a surface or gap for conducting droplet operations. The one or more substrates establish a droplet operations surface or gap for conducting droplet operations and may also include electrodes arrange to conduct the droplet operations. The droplet operations substrate or the gap between the substrates may be coated or filled with a filler fluid that is immiscible with the liquid that forms the droplets.

Droplet actuators are useful for certain bead washing operations. There is a need for new approaches that simplify bead washing operations in droplet actuators.

In droplet actuators in which droplet operations are conducted in contact with a filler fluid, droplet contents can be lost from droplets into the filler fluid, and may sometimes travel into other droplets via the filler fluid. There is a need for techniques which help to contain substances in aqueous droplets in droplet actuators.

In manufacturing droplet actuators, it is important to control the manufacturing process in a manner which produces the intended gap height. There is a means for systems and methods for testing gap height within a droplet actuator.

### 4 SUMMARY OF THE INVENTION

The invention provides a method of determining gap height in a droplet actuator. The method includes measuring impedance between a droplet operations electrode of a first substrate in a droplet actuator and ground electrode of a second substrate in the droplet actuator. The first substrate may be, for example, the base substrate. The method may include storing a lookup table that associates impedances to heights of gaps between the first substrate and the second substrate. The method may include querying the lookup table for the impedance measured between the droplet operations electrode of the first substrate and the ground electrode of the second substrate The method may include retrieving a height of a gap associated with the impedance. The method may include retrieving a location of the droplet operations electrode in the droplet actuator. The method may include mapping the location of the droplet operations electrode and the height of the gap associated with the droplet operations electrode. The method may include mapping the location of the droplet operations electrode and the impedance associated with the droplet operations electrode. The method may include comparing the height of the gap to a specification. The method may include storing the impedances associated with all droplet operations electrodes in the droplet actuator.

The invention also provides systems for performing the methods of the invention. For example, a system may include a processor; memory; and code stored in the memory that when executed causes the processor perform one or more of the methods of the invention or one or more steps of the methods of the invention.

5 DEFINITIONS

As used herein, the following terms have the meanings indicated.

“Activate,” with reference to one or more electrodes, means affecting a change in the electrical state of the one or more electrodes which, in the presence of a droplet, results in a droplet operation. Activation of an electrode can be accomplished using alternating or direct current. Any suitable voltage may be used. For example, an electrode may be activated using a voltage which is greater than about 150 V, or greater than about 200 V, or greater than about 250 V, or from about 275 V to about 375 V, or about 300 V. Where alternating current is used, any suitable frequency may be employed. For example, an electrode may be activated using alternating current having a frequency from about 1 Hz to about 1000 Hz, or from about 1 Hz to about 100 Hz, or from about 10 Hz to about 60 Hz, or from about 20 Hz to about 40 Hz, or about 30 Hz.

“Bead,” with respect to beads on a droplet actuator, means any bead or particle that is capable of interacting with a droplet on or in proximity with a droplet actuator. Beads may be any of a wide variety of shapes, such as spherical, generally spherical, egg shaped, disc shaped, cubical, amorphous and other three dimensional shapes. The bead may, for example, be capable of being subjected to a droplet operation in a droplet on a droplet actuator or otherwise configured with respect to a droplet actuator in a manner which permits a droplet on the droplet actuator to be brought into contact with the bead on the droplet actuator and/or off the droplet actuator. Beads may be provided in a droplet, in a droplet operations gap, or on a droplet operations surface. Beads may be provided in a reservoir that is external to a droplet operations gap or situated apart from a droplet operations surface, and the reservoir may be associated with a fluid path that permits a droplet including the beads to be brought into a droplet operations gap or into contact with a droplet operations surface. Beads may be manufactured using a wide variety of materials, including for example, resins, and polymers. The beads may be any suitable size, including for example, microbeads, microparticles, nanobeads and nanoparticles. In some cases, beads are magnetically responsive; in other cases beads are not significantly magnetically responsive. For magnetically responsive beads, the magnetically responsive material may constitute substantially all of a bead, a portion of a bead, or only one component of a bead. The remainder of the bead may include, among other things, polymeric material, coatings, and moieties which permit attachment of an assay reagent. Examples of suitable beads include flow cytometry microbeads, polystyrene microparticles and nanoparticles, functionalized polystyrene microparticles and nanoparticles, coated polystyrene microparticles and nanoparticles, silica microbeads, fluorescent microspheres and nanospheres, functionalized fluorescent microspheres and nanospheres, coated fluorescent microspheres and nanospheres, color dyed microparticles and nanoparticles, magnetic microparticles and nanoparticles, superparamagnetic microparticles and nanoparticles (e.g., DYNABEADS® particles, available from Invitrogen Group, Carlsbad, Calif.), fluorescent microparticles and nanoparticles, coated magnetic microparticles and nanoparticles, ferromagnetic microparticles and nanoparticles, coated ferromagnetic microparticles and nanoparticles, and those described in U.S. Patent Publication Nos. 20050260686, entitled “Multiplex flow assays preferably with magnetic particles as solid phase,” published on Nov. 24, 2005; 20030132538, entitled “Encapsulation of discrete quanta of fluorescent particles,” published on Jul. 17, 2003; 20050118574, entitled “Multiplexed Analysis of Clinical Specimens Apparatus and Method,” published on Jun. 2, 2005; 20050277197. Entitled “Microparticles with Multiple Fluorescent Signals and Methods of Using Same,” published on Dec. 15, 2005; 20060159962, entitled “Magnetic Microspheres for use in Fluorescence-based Applications,” published on Jul. 20, 2006; the entire disclosures of which are incorporated herein by reference for their teaching concerning beads and magnetically responsive materials and beads. Beads may be pre-coupled with a biomolecule or other substance that is able to bind to and form a complex with a biomolecule. Beads may be pre-coupled with an antibody, protein or antigen, DNA/RNA probe or any other molecule with an affinity for a desired target. Examples of droplet actuator techniques for immobilizing magnetically responsive beads and/or non-magnetically responsive beads and/or conducting droplet operations protocols using beads are described in U.S. patent application Ser. No. 11/639,566, entitled “Droplet-Based Particle Sorting,” filed on Dec. 15, 2006; U.S. Patent Application No. 61/039,183, entitled “Multiplexing Bead Detection in a Single Droplet,” filed on Mar. 25, 2008; U.S. Patent Application No. 61/047,789, entitled “Droplet Actuator Devices and Droplet Operations Using Beads,” filed on Apr. 25, 2008; U.S. Patent Application No. 61/086,183, entitled “Droplet Actuator Devices and Methods for Manipulating Beads,” filed on Aug. 5, 2008; International Patent Application No. PCT/US2008/053545, entitled “Droplet Actuator Devices and Methods Employing Magnetic Beads,” filed on Feb. 11, 2008; International Patent Application No. PCT/US2008/058018, entitled “Bead-based Multiplexed Analytical Methods and Instrumentation,” filed on Mar. 24, 2008; International Patent Application No. PCT/US2008/058047, “Bead Sorting on a Droplet Actuator,” filed on Mar. 23, 2008; and International Patent Application No. PCT/US2006/047486, entitled “Droplet-based Biochemistry,” filed on Dec. 11, 2006; the entire disclosures of which are incorporated herein by reference. Bead characteristics may be employed in the multiplexing aspects of the invention. Examples of beads having characteristics suitable for multiplexing, as well as methods of detecting and analyzing signals emitted from such beads, may be found in U.S. Patent Publication No. 20080305481, entitled “Systems and Methods for Multiplex Analysis of PCR in Real Time,” published on Dec. 11, 2008; U.S. Patent Publication No. 20080151240, “Methods and Systems for Dynamic Range Expansion,” published on Jun. 26, 2008; U.S. Patent Publication No. 20070207513, entitled “Methods, Products, and Kits for Identifying an Analyte in a Sample,” published on Sep. 6, 2007; U.S. Patent Publication No. 20070064990, entitled “Methods and Systems for Image Data Processing,” published on Mar. 22, 2007; U.S. Patent Publication No. 20060159962, entitled “Magnetic Microspheres for use in Fluorescence-based Applications,” published on Jul. 20, 2006; U.S. Patent Publication No. 20050277197, entitled “Microparticles with Multiple Fluorescent Signals and Methods of Using Same,” published on Dec. 15, 2005; and U.S. Patent Publication No. 20050118574, entitled “Multiplexed Analysis of Clinical Specimens Apparatus and Method,” published on Jun. 2, 2005.

“Droplet” means a volume of liquid on a droplet actuator. Typically, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the invention, see International Patent Application No. PCT/US 06/47486, entitled, “Droplet-Based Biochemistry,” filed on Dec. 11, 2006. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. patent application Ser. No. 11/343,284, entitled “Apparatuses and Methods for Manipulating Droplets on a Printed Circuit Board,” filed on filed on Jan. 30, 2006; Pollack et al., International Patent Application No. PCT/US2006/047486, entitled “Droplet-Based Biochemistry,” filed on Dec. 11, 2006; Shenderov, U.S. Pat. No. 6,773,566, entitled “Electrostatic Actuators for Microfluidics and Methods for Using Same,” issued on Aug. 10, 2004 and U.S. Pat. No.6,565,727, entitled “Actuators for Microfluidics Without Moving Parts,” issued on Jan. 24, 2000; Kim and/or Shah et al., U.S. patent application Ser. No. 10/343,261, entitled “Electrowetting-driven Micropumping,” filed on Jan. 27, 2003, Ser. No. 11/275,668, entitled “Method and Apparatus for Promoting the Complete Transfer of Liquid Drops from a Nozzle,” filed on Jan. 23, 2006, Ser. No. 11/460,188, entitled “Small Object Moving on Printed Circuit Board,” filed on Jan. 23, 2006, Ser. No. 12/465,935, entitled “Method for Using Magnetic Particles in Droplet Microfluidics,” filed on May 14, 2009, and Ser. No. 12/513,157, entitled “Method and Apparatus for Real-time Feedback Control of Electrical Manipulation of Droplets on Chip,” filed on Apr. 30, 2009; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker and Gascoyne et al., U.S. Pat. No. 7,641,779, entitled “Method and Apparatus for Programmable fluidic Processing,” issued on Jan. 5, 2010, and U.S. Pat. No. 6,977,033, entitled “Method and Apparatus for Programmable fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, International Patent Pub. No. WO/2009/003184, entitled “Digital Microfluidics Based Apparatus for Heat-exchanging Chemical Processes,” published on Dec. 31, 2008; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; March and et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between two or Several Solid Substrates,” published on Aug. 18, 2005; Dhindsa et al., “Virtual Electrowetting Channels: Electronic Liquid Transport with Continuous Channel Functionality,” Lab Chip, 10:832-836 (2010); the entire disclosures of which are incorporated herein by reference, along with their priority documents. Certain droplet actuators will include one or more substrates arranged with a gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the invention. During droplet operations it is preferred that droplets remain in continuous contact or frequent contact with a ground or reference electrode. A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, N.J.) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap therebetween and define dispensing reservoirs. The spacer height may, for example, be from about 5 μm to about 600 μm, or about 100 μm to about 400 μm, or about 200 μm to about 350 μm, or about 250 μm to about 300 μm, or about 275 μm. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the invention include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the invention. Similarly, one or more of the foregoing may be used to deliver liquid into a droplet operations gap, e.g., from a reservoir in another device or from an external reservoir of the droplet actuator (e.g., a reservoir associated with a droplet actuator substrate and a fluid path from the reservoir into the droplet operations gap). Droplet operations surfaces of certain droplet actuators of the invention may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), and other fluorinated monomers for plasma-enhanced chemical vapor deposition (PECVD). In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS). Other examples of electrically conducting organic polymers and alternative conductive layers are described in Pollack et al., International Patent Application No. PCT/US2010/040705, entitled “Droplet Actuator Devices and Methods,” the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating is preferably a thickness in the range of about 20 to about 200 nm, preferably about 50 to about 150 nm, or about 75 to about 125 nm, or about 100 nm. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose, Calif.); ARLON™ 11N (available from Arlon, Inc, Santa Ana, Calif.); NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclic olefin copolymer (COC); cyclic olefin polymer (COP); aramid; THERMOUNT® nonwoven aramid reinforcement (available from DuPont, Wilmington, Del.); NOMEX® brand fiber (available from DuPont, Wilmington, Del.); and paper. Various materials are also suitable for use as the dielectric component of the substrate. Examples include: vapor deposited dielectric, such as PARYLENE™ C (especially on glass) and PARYLENE™ N (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., FEP), polytetrafluoroethylene; polyester; polyethylene naphthalate; cyclic olefin copolymer (COC); cyclic olefin polymer (COP); any other PCB substrate material listed above; black matrix resin; and polypropylene. Droplet transport voltage and frequency may be selected for performance with reagents used in specific assay protocols. Design parameters may be varied, e.g., number and placement of on-chip reservoirs, number of independent electrode connections, size (volume) of different reservoirs, placement of magnets/bead washing zones, electrode size, inter-electrode pitch, and gap height (between top and bottom substrates) may be varied for use with specific reagents, protocols, droplet volumes, etc. In some cases, a substrate of the invention may derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, and other fluorinated monomers for plasma-enhanced chemical vapor deposition (PECVD). Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator are typically controlled by a controller or a processor, which is itself provided as part of a system, which may include processing functions as well as data and software storage and input and output capabilities.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance or capacitance sensing or imaging techniques may sometimes be used to determine or confirm the outcome of a droplet operation. Examples of such techniques are described in Sturmer et al., International Patent Pub. No. WO/2008/101194, entitled “Capacitance Detection in a Droplet Actuator,” published on Aug. 21, 2008, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may exceed about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to electrowetting area; in other words, 1×-, 2×-3×-droplets are usefully controlled operated using 1, 2, and 3 electrodes, respectively. If the droplet footprint is greater than the number of electrodes available for conducting a droplet operation at a given time, the difference between the droplet size and the number of electrodes should typically not be greater than 1; in other words, a 2× droplet is usefully controlled using 1 electrode and a 3× droplet is usefully controlled using 2 electrodes. When droplets include beads, it is useful for droplet size to be equal to the number of electrodes controlling the droplet, e.g., transporting the droplet.

“Filler fluid” means a fluid associated with a droplet operations substrate of a droplet actuator, which fluid is sufficiently immiscible with a droplet phase to render the droplet phase subject to electrode-mediated droplet operations. For example, the gap of a droplet actuator is typically filled with a filler fluid. The filler fluid may, for example, be a low-viscosity oil, such as silicone oil or hexadecane filler fluid. The filler fluid may fill the entire gap of the droplet actuator or may coat one or more surfaces of the droplet actuator. Filler fluids may be conductive or non-conductive. Filler fluids may, for example, be doped with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the invention are provided in Srinivasan et al, International Patent Pub. Nos. WO/2010/027894, entitled “Droplet Actuators, Modified Fluids and Methods,” published on Mar. 11, 2010, and WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Aug. 14, 2008; and Monroe et al., U.S. Patent Publication No. 20080283414, entitled “Electrowetting Devices,” filed on May 17, 2007; the entire disclosures of which are incorporated herein by reference, as well as the other patents and patent applications cited herein.

“Immobilize” with respect to magnetically responsive beads, means that the beads are substantially restrained in position in a droplet or in filler fluid on a droplet actuator. For example, in one embodiment, immobilized beads are sufficiently restrained in position in a droplet to permit execution of a droplet splitting operation, yielding one droplet with substantially all of the beads and one droplet substantially lacking in the beads.

“Magnetically responsive” means responsive to a magnetic field. “Magnetically responsive beads” include or are composed of magnetically responsive materials. Examples of magnetically responsive materials include paramagnetic materials, ferromagnetic materials, ferrimagnetic materials, and metamagnetic materials. Examples of suitable paramagnetic materials include iron, nickel, and cobalt, as well as metal oxides, such as Fe₃O₄, BaFe₁₂O₁₉, CoO, NiO, Mn₂O₃, Cr₂O₃, and CoMnP.

“Transporting into the magnetic field of a magnet,” “transporting towards a magnet,” and the like, as used herein to refer to droplets and/or magnetically responsive beads within droplets, is intended to refer to transporting into a region of a magnetic field capable of substantially attracting magnetically responsive beads in the droplet. Similarly, “transporting away from a magnet or magnetic field,” “transporting out of the magnetic field of a magnet,” and the like, as used herein to refer to droplets and/or magnetically responsive beads within droplets, is intended to refer to transporting away from a region of a magnetic field capable of substantially attracting magnetically responsive beads in the droplet, whether or not the droplet or magnetically responsive beads is completely removed from the magnetic field. It will be appreciated that in any of such cases described herein, the droplet may be transported towards or away from the desired region of the magnetic field, and/or the desired region of the magnetic field may be moved towards or away from the droplet. Reference to an electrode, a droplet, or magnetically responsive beads being “within” or “in” a magnetic field, or the like, is intended to describe a situation in which the electrode is situated in a manner which permits the electrode to transport a droplet into and/or away from a desired region of a magnetic field, or the droplet or magnetically responsive beads is/are situated in a desired region of the magnetic field, in each case where the magnetic field in the desired region is capable of substantially attracting any magnetically responsive beads in the droplet. Similarly, reference to an electrode, a droplet, or magnetically responsive beads being “outside of or “away from” a magnetic field, and the like, is intended to describe a situation in which the electrode is situated in a manner which permits the electrode to transport a droplet away from a certain region of a magnetic field, or the droplet or magnetically responsive beads is/are situated away from a certain region of the magnetic field, in each case where the magnetic field in such region is not capable of substantially attracting any magnetically responsive beads in the droplet or in which any remaining attraction does not eliminate the effectiveness of droplet operations conducted in the region. In various aspects of the invention, a system, a droplet actuator, or another component of a system may include a magnet, such as one or more permanent magnets (e.g., a single cylindrical or bar magnet or an array of such magnets, such as a Halbach array) or an electromagnet or array of electromagnets, to form a magnetic field for interacting with magnetically responsive beads or other components on chip. Such interactions may, for example, include substantially immobilizing or restraining movement or flow of magnetically responsive beads during storage or in a droplet during a droplet operation or pulling magnetically responsive beads out of a droplet.

“Washing” with respect to washing a bead means reducing the amount and/or concentration of one or more substances in contact with the bead or exposed to the bead from a droplet in contact with the bead. The reduction in the amount and/or concentration of the substance may be partial, substantially complete, or even complete. The substance may be any of a wide variety of substances; examples include target substances for further analysis, and unwanted substances, such as components of a sample, contaminants, and/or excess reagent. In some embodiments, a washing operation begins with a starting droplet in contact with a magnetically responsive bead, where the droplet includes an initial amount and initial concentration of a substance. The washing operation may proceed using a variety of droplet operations. The washing operation may yield a droplet including the magnetically responsive bead, where the droplet has a total amount and/or concentration of the substance which is less than the initial amount and/or concentration of the substance. Examples of suitable washing techniques are described in Pamula et al., U.S. Pat. No. 7,439,014, entitled “Droplet-Based Surface Modification and Washing,” granted on Oct. 21, 2008, the entire disclosure of which is incorporated herein by reference.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

### 6 BRIEF DESCRIPTION OF THE DRAWINGS

FIGS. 1A, 1B and 1C illustrate top views of an example of a portion of an electrode arrangement of a droplet actuator and a method of washing beads in a droplet actuator;

FIG. 2A illustrates a top down view of an example of a droplet actuator that is connected to an impedance sensing system for determining variations in droplet actuator gap height;

FIG. 2B illustrates a cross-sectional view of the droplet actuator of FIG. 2A, taken along line AA of FIG. 2A;

FIG. 3 illustrates a cross-sectional view of an example of a portion of a droplet actuator that includes substrates that have undergone a hydrophobic plasma treatment process for achieving low surface-energy surfaces;

FIG. 4 illustrates a cross-sectional view of another example of a portion of a droplet actuator that includes substrates that have undergone certain processes for achieving low surface-energy surfaces;

FIG. 5 illustrates a top view of an example of a bottom substrate and a corresponding top substrate, which is an example implementation of the droplet actuator of FIG. 4; and

FIG. 6 illustrates a top view of the underside (i.e., the surface facing the gap when assembled) of the top substrate of FIG. 5.

### 7 DESCRIPTION

The invention provides a method of washing beads in a droplet actuator. For example, the method of the invention provides a process of washing beads that eliminates the need to move a bead droplet away from a magnet during the wash cycles.

The invention provides a method using an impedance sensing system that is connected to a droplet actuator for determining variations in droplet actuator gap height. For example, the impedance sensing system may be used in a quality control process to determine whether the gap height of a droplet actuator is substantially uniform.

Further, the invention provides low surface-energy surfaces in droplet actuators that may be produced by plasma technology, such as a hydrophobic plasma treatment process. For example, the droplet operations surface of the top and bottom substrate of a droplet actuator experience the hydrophobic plasma treatment process. In this way, the droplet operations surfaces of a droplet actuator are low surface-energy surfaces for improving the containment of analytes in aqueous droplets in droplet actuators, which is beneficial for the prevention of sample contamination in certain applications, such as newborn screening assays. Optionally, the outer surface of the top substrate (i.e., the non-droplet operations surface) of a droplet actuator also undergoes the hydrophobic plasma treatment process. The present invention also describes examples of plasma treatment processes and materials for fabricating hydrophobic coatings.

7.1 Bead Handling in a Droplet Actuator

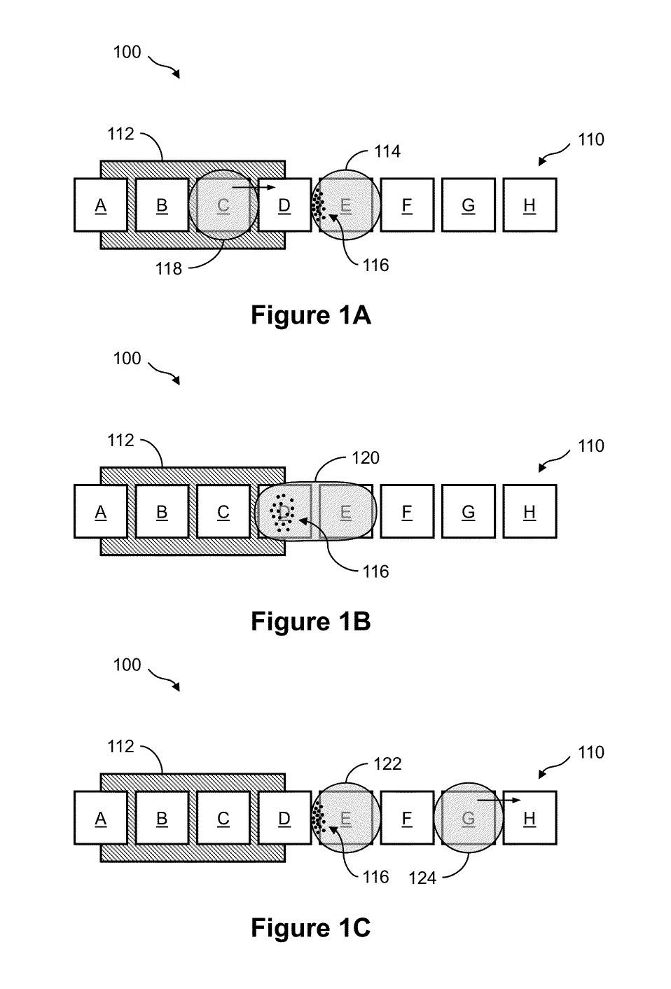

FIGS. 1A, 1B and 1C illustrate top views of an example of a portion of an electrode arrangement 100 of a droplet actuator and a method of washing beads in a droplet actuator. In this example, electrode arrangement 100 may include a line, path, and/or array of droplet operations electrodes 110 (e.g., electrowetting electrodes). For example, FIGS. 1A, 1B and 1C show droplet operations electrodes 110A through 110H. Droplet operations are conducted atop droplet operations electrodes 110 on a droplet operations surface. A magnet 112 is arranged in close proximity to certain droplet operations electrodes 110, such that the droplet operations electrodes 110 are within the magnetic field of magnet 112. Magnet 112 may be a permanent magnet or an electromagnet.

Currently, during bead washing operations, a bead droplet is moved away from the magnet and then moved back to the magnet so that unbound materials that may be trapped between the beads can be freed up. The freed up material is then washed away in subsequent washes. The present invention provides a process of washing beads that eliminates the need to move the bead droplet away from the magnet during the wash cycles. The bead washing method of the invention may include, but is not limited to, the following steps.

Referring to FIG. 1A, a bead droplet 114 that contains magnetically responsive beads 116 is positioned atop a certain droplet operations electrode 110. Bead droplet 114 is positioned slightly away from the edge of magnet 112. For example, bead droplet 114 is positioned at droplet operations electrode 110E, which is slightly away from the edge of magnet 112. As a result, the magnetically responsive beads 116 are clustered at the side of bead droplet 114 that is nearest magnet 112. FIG. 1A also shows a wash droplet 118 on the magnet-side of bead droplet 114 and moving via droplet operations toward the bead droplet 114.

Because the magnetically responsive beads 116 are clustered together in the magnetic field, as shown in FIG. 1A, unbound material may be trapped in the small spaces between the clustered magnetically responsive beads 116.

Referring to FIG. 1B, wash droplet 118 is merged with bead droplet 114 to form a 2× merged droplet 120. A portion of 2× merged droplet 120 is at magnet 112. For example, 2× merged droplet 120 is atop droplet operations electrodes 110D and 110E, where droplet operations electrode 110D is at magnet 112 and droplet operations electrode 110E is slightly away from the edge of magnet 112. Because the magnetic field of magnet 112 is stronger at droplet operations electrode 110D than at droplet operations electrode 110E, magnetically responsive beads 116 are attracted to droplet operations electrode 110D. Additionally, because 2× merged droplet 120 is a 2× droplet, magnetically responsive beads 116 tend to re-suspend in the fluid, rather than stay clustered.

Because the magnetically responsive beads 116 are no longer clustered together, any unbound material that was once trapped in the small spaces between the clustered magnetically responsive beads 116 is freed up and suspended in the fluid of 2× merged droplet 120.

Referring to FIG. 1C, a droplet splitting operation occurs in which 2× merged droplet 120 is split. A droplet 122 that contains the washed magnetically responsive beads 116 is left behind at, for example, droplet operations electrode 110E. A waste droplet 124 is moved away from droplet 122 via droplet operations. Carried away with waste droplet 124 is the unbound material that was freed up in the previous step (FIG. 1B). The magnetically responsive beads 116, which have been washed, are again clustered at the side of droplet 122 that is nearest magnet 112.

An aspect of the bead washing method of the invention is that it provides a one-step washing process. That is, there is no requirement to move the bead droplet of interest back and forth with respect to the magnet and/or to more the magnet back and forth with respect to the bead droplet. Further, an improved washing operation is provided that saves time.

7.2 Determining Gap Height in Droplet Actuators

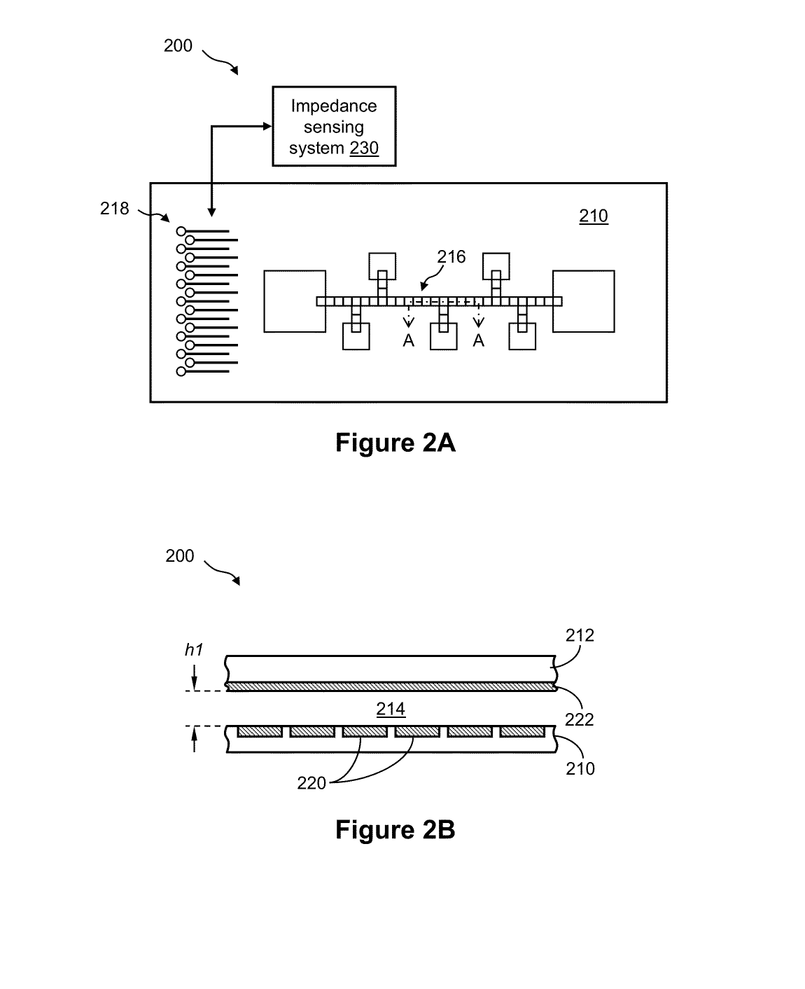

FIG. 2A illustrates a top down view of an example of a droplet actuator 200 that is connected to an impedance sensing system for determining variations in droplet actuator gap height. FIG. 2B illustrates a cross-sectional view of droplet actuator 200, taken along line AA of FIG. 2A.

In this example, droplet actuator 200 may include a bottom substrate 210 and a top substrate 212 that are separated by a gap 214. Bottom substrate 210 may, for example, be a printed circuit board (PCB). Top substrate 212 may, for example, be formed of glass, injection-molded plastic, silicon, and/or indium tin oxide (ITO). An electrode arrangement 216 and a set of input/output (I/O) pads 218 may be patterned on bottom substrate 210. Electrode arrangement 216 may include a line, path, and/or array of droplet operations electrodes 220 (e.g., electrowetting electrodes). Droplet operations are conducted atop droplet operations electrodes 220 on a droplet operations surface. Additionally, a ground reference electrode 222 may be patterned on top substrate 212.

I/O pads 218 are contacts that are connected by wiring traces to the electrodes, such as to droplet operations electrodes 220. In one example, I/O pads 218 are used for applying electrowetting voltages. When a droplet actuator, such as droplet actuator 200, is installed in a microfluidics system (not shown), I/O pads 218 are coupled to a controller, which includes the circuitry for detecting impedance at a specific electrode. One I/O pad 218 may be coupled to the top plate to provide the return path for the circuit. FIG. 2A also shows an impedance sensing system 230, which is one example of circuitry for detecting impedance at a specific electrode. Impedance sensing system 230 may be, for example, an impedance spectrometer.

Impedance sensing system 230 may be used to monitor the capacitive loading of any electrode, such as any droplet operations electrode 220, with or without a droplet thereon. For examples of suitable capacitance detection techniques, see Sturmer et al., International Patent Publication No. WO/2008/101194, entitled “Capacitance Detection in a Droplet Actuator,” published on Aug. 21, 2008; and Kale et al., International Patent Publication No. WO/2002/080822, entitled “System and Method for Dispensing Liquids,” published on Oct. 17, 2002; the entire disclosures of which are incorporated herein by reference.

According to the invention, impedance sensing system 230 may be used in, for example, a quality control process to determine whether the gap height h1 across the area of the droplet actuator is substantially the expected height and uniformity, within a predetermined acceptable tolerance. This is because, in a droplet actuator, there is a correlation between gap height and the measured electrode impedance value. The correlation of gap heights to impedance values may be predetermined by any means and stored in, for example, a lookup table.

According to the invention, impedance sensing system 230 may be used to capture an impedance measurement between any droplet operations electrode 220 of bottom substrate 210 and ground reference electrode 222 of top substrate 212. For example, impedance sensing system 230 scans the line, path, and/or array of droplet operations electrodes 220 and an impedance measurement may be stored for each individual droplet operations electrode 220 of droplet actuator 200.

Then, using the lookup table of gap height-to-impedance value, the impedance measurements corresponding to the respective droplet operations electrodes 220 may be mapped with respect to gap heights. Further, because the physical location of each droplet operations electrode 220 is known with respect to the area of the droplet actuator, the gap heights may be mapped with respect to droplet actuator locations. In this way, it may be determined whether the gap height across the area of a certain droplet actuator is in or out of a predetermined specification.

An aspect of the invention is that it provides a simple method of determining variations in droplet actuator gap height, in which the method requires no special optical or mechanical mechanisms.

7.3 Low Surface Energy Surfaces Produced by Plasma Technology

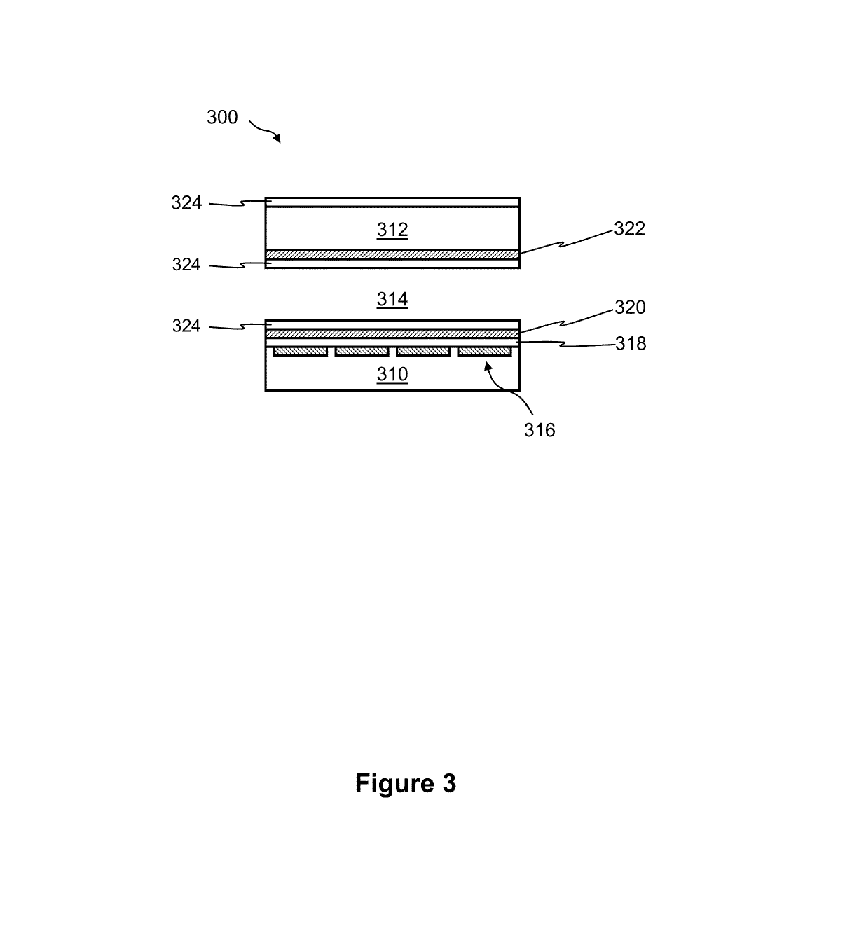

FIG. 3 illustrates a cross-sectional view of an example of a portion of a droplet actuator 300 that includes substrates that have undergone a hydrophobic plasma treatment process for achieving low surface-energy surfaces. Droplet actuator 300 may include a bottom substrate 310 that is separated from a top substrate 312 by a gap 314. Bottom substrate 310 may be formed, for example, of silicon, glass, plastic or printed circuit board (PCB). Top substrate 312 may be formed, for example, of glass; polymethylmethacrylate (PMMA); polycarbonate (PC), cyclic olefin polymer (COP); cyclic olefin copolymer (COC); polystyrene or other plastics that are fabricated through injection-molding, lamination, printing, or by any other means; and any combinations thereof. Bottom substrate 310 may include an arrangement of droplet operations electrodes 316 (e.g., electrowetting electrodes). Droplet operations are conducted atop droplet operations electrodes 316 on a droplet operations surface.

An adhesive layer 318 is applied atop droplet operations electrodes 316 of bottom substrate 310 for bonding to a dielectric layer 320 that is facing gap 314. Dielectric layer 320 may be formed, for example, of KAPTON® or any other material that has dielectric properties. A conductive layer 322 is applied on the surface of top substrate 312 that is facing gap 314. Conductive layer 322 may be formed of an electrically conductive material. Preferably conductive layer 322 is substantially optically transparent. Conductive layer 322 may be formed, for example, of ITO or a conductive ink, such as organic conducting polymers (PEDOT:PSS).

Certain surfaces of bottom substrate 310 and/or top substrate 312 may be coated with a hydrophobic layer 324. For example, a hydrophobic layer 324 is provided atop the dielectric layer 320 of bottom substrate 310. Additionally, a hydrophobic layer 324 is provided atop the conductive layer 322 of top substrate 312. Optionally, a hydrophobic layer 324 is provided at the outer surface of top substrate 312 (i.e., the non-droplet operations surface) of droplet actuator 300. In this way, droplet actuator 300 may include multiple hydrophobic layers 324. One reason that a hydrophobic layer 324 may be provided at the outer surface of top substrate 312 is to allow for proper transfer of aqueous liquids from top reservoirs (not shown) through top substrate 312 and into the gap 314 of droplet actuator 300.

The hydrophobic layers 324 of droplet actuator 300 are low surface-energy surfaces for improving the containment of analytes in aqueous droplets in droplet actuators, which is beneficial for the prevention of sample contamination in certain applications, such as newborn screening assays.

A main aspect of the present invention is the ability to produce robust (ideally, covalently-attached) hydrophobic films at low temperature (<80 ° C.) on, for example, the following substrate materials: polymethylmethacrylate (PMMA); polycarbonate (PC), cyclic olefin polymer (COP); cyclic olefin copolymer (COC); polyimide (PI, e.g., KAPTON®), organic conducting polymers (PEDOT:PSS), and ITO. Another aspect of the present invention is the ability to produce thin and smooth films (e.g., 10-1,000 nm thick, roughness <10 nm).

Other important considerations with respect to applying the hydrophobic layers in droplet actuators are water contact angle hysteresis, limits of usable space of electrowetting-on-dielectric (EWOD) parameters (e.g., voltage, frequency, etc), and the degree of containment of the analyte/detected entity in various assay types of interest. More specifically, important characteristics of the hydrophobic layers may include, but are not limited to, the following.
stable upon exposure to pH range 2-11;
stable upon exposure to organics such as fluorinated liquids (e.g., filler fluids in EWOD applications);
exhibit strong mechanical adhesion to the substrate (via a peel or scratch test);
optically transparent (>80% transmittance for the 10-1000 nm thickness range) in the 250-700 nm range;
exhibit high water contact angles (>110 degrees in air, maybe >160 in oil);
exhibit low water contact angle hysteresis (<10 degrees);
respond to subsequent plasma activation to enable their bonding with adhesives (top plate/bottom plate bonding); and
demonstrate better performance than the current hydrophobic coatings that are used, such as Cytop hydrophobic coatings.

The materials used to form the hydrophobic layers, such as the hydrophobic layers 324 of droplet actuator 300, fall under the broad category of fluorinated coatings (with added dial-in control of surface texture in the case of a laser-based surface texturing technology by NASA). The choice of specific materials may be subject to the type of plasma technology used to form the hydrophobic layers. Examples of plasma treatment processes and materials for fabricating hydrophobic coatings include, but are not limited to, those shown in the following table.

| Plasma Treatment Process | Coating Material |
|---|---|
| Atmospheric Plasma Curing | Liquid Fluoroalkysilane |
| | Precursors |
| Initiated and Oxidative Chemical Vapor | Polytetrafluoroethylene |
| Deposition (iCVD and oCVD) | (PTFE) |
| Plasmatreat's Openair ® plasma and | Organosilicon Compound |
| PlasmaPlus ® | |
| Atmospheric Pressure Plasma Liquid | N/A |
| Deposition (APPLD) | |
| Inline Plasma Treatment | Acrylate monomers |
| Monomer Flash Evaporation | Acrylate monomers |
| Liquid Monomer Deposition | Acrylate monomers |
| Radiation Curing with Electron Beam | Acrylate monomers |
| or UV | |
| Sprayed | Self-Assembled Monolayer of |
| | Phosphonates (SAMP) |
| Dipped | Self-Assembled Monolayer of |
| | Phosphonates (SAMP) |
| Ink-jet printing | Self-Assembled Monolayer of |
| | Phosphonates (SAMP) |
| Roll coating/gravure rod | Self-Assembled Monolayer of |
| | Phosphonates (SAMP) |
| Stamping | Self-Assembled Monolayer of |
| | Phosphonates (SAMP) |
| Plasma Enhanced Chemical Vapor | Acrylate monomers |
| Deposition (Aridion ™) | |
| Plasma Enhanced Chemical Vapor | Isocyanate and Perfluoro |
| Deposition (PECVD) | Silanes Precursors |

Note:
Some processes are implemented in vacuum chambers, others at atmospheric pressure, and others in the open.

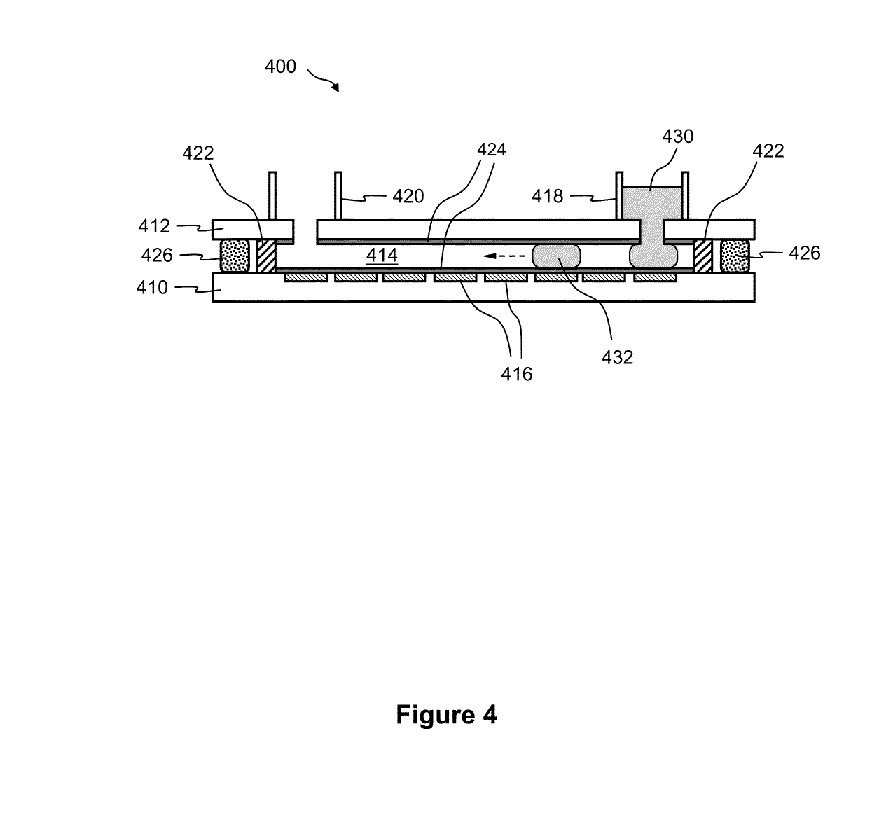

FIG. 4 illustrates a cross-sectional view of another example of a portion of a droplet actuator 400 that includes substrates that have undergone certain processes for achieving low surface-energy surfaces. Droplet actuator 400 may include a bottom substrate 410 that is separated from a top substrate 412 by a gap 414. Bottom substrate 410 may be formed, for example, of silicon, glass, plastic or a PCB. Top substrate 412 may be formed, for example, of glass; PMMA; PC, COP; COC; polystyrene or other plastics that are fabricated through injection-molding, lamination, printing, or by any other means; and any combinations thereof. Bottom substrate 410 may include an arrangement of droplet operations electrodes 416 (e.g., electrowetting electrodes). Droplet operations are conducted atop droplet operations electrodes 416 on a droplet operations surface.

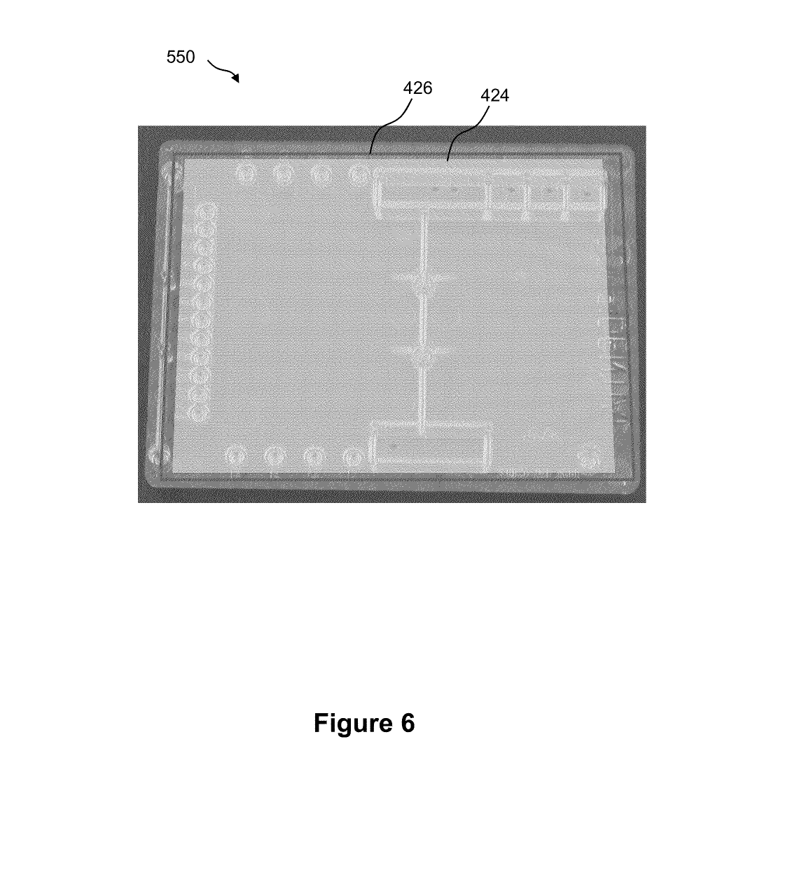

Certain fluid wells may be incorporated into top substrate 412 of droplet actuator 400. For example, a sample fluid well 418 and a waste fluid well 420 may be incorporated into top substrate 412. Additionally, certain gap setting features may be installed between bottom substrate 410 and top substrate 412 of droplet actuator 400. For example, a spacer 422 may be installed between bottom substrate 410 and top substrate 412 for setting the gap height. Additionally, certain surfaces of bottom substrate 410 and/or top substrate 412 may be coated with a hydrophobic layer 424. For example, a hydrophobic layer 424 is provided on the surface facing gap 414 of both bottom substrate 410 and top substrate 412. The coverage of these hydrophobic layers 424 may be limited to within the area bounded by spacers 422, an example of which is shown in FIG. 6.

Spacer 422 may be in the form of a line that substantially follows the parameter of droplet actuator 400. Further, there is suitable distance between spacer 422 and the edge of droplet actuator 400 to allow a line of adhesive 426 to be applied. Like spacer 422, the line of adhesive 426 may substantially follow the parameter of droplet actuator 400. In doing so, a bond line is formed, an example of which is shown in FIG. 6. Preferably, the absence of hydrophobic material (e.g., hydrophobic layer 424) at the periphery of droplet actuator 400 is required to enable proper bonding with adhesive. The deposition of hydrophobic material at this location may be prevented by masking. Alternatively, the hydrophobic material may be removed post-deposition.

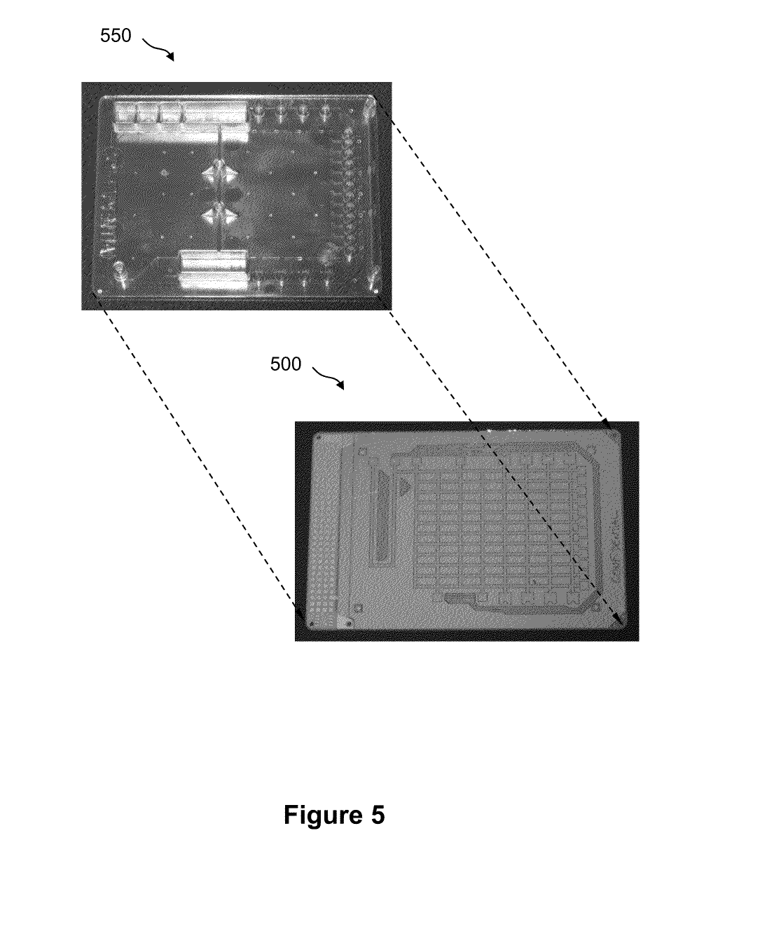

FIG. 4 shows droplet actuator 400 in operation. For example, a sample fluid 430 is dispensed from sample fluid well 418 and sample droplets 432 are transported along droplet operations electrodes 416 via droplet operations, for example, toward waste fluid well 420. FIGS. 5 and 6 show an example of a specific instantiation of droplet actuator 400.

FIG. 5 illustrates a top view of an example of a bottom substrate 500 and a corresponding top substrate 550. Again, these example substrates have undergone certain processes for achieving low surface-energy surfaces. Bottom substrate 500 is one example of bottom substrate 410 of droplet actuator 400 of FIG. 4. In this example, bottom substrate 500 may be about 80 mm wide, about 130 mm long and about 2 mm thick. Top substrate 550 is one example of top substrate 412 of droplet actuator 400 of FIG. 4. In this example, top substrate 550 may be about 80 mm wide, about 120 mm long and about 10 mm thick. FIG. 6 illustrates a top view of the underside (i.e., the surface facing the gap when assembled) of top substrate 550. In this view, it is shown that the coverage area of hydrophobic layer 424 is contained within the area bounded by the line of adhesive 426.

Referring again to FIGS. 4, 5, and 6, various processes may be used for depositing the hydrophobic layers (e.g., hydrophobic layers 424) of the substrates. In one example, the hydrophobic layers may be implemented using perfluorination of polymer surfaces by plasma-enhanced chemical vapor deposition (PECVD). With respect to the PECVD process, a direct spray or vacuum deposition process may be preferred. However, an inkjet process is possible. In this example, the hydrophobic layers are formed of a perfluorination compound (e.g., silane) deposited by PECVD. The final film thickness is about 10 nm to about 500 nm, preferably about 20 nm to about 200 nm. Further, the advancing water contact angle (θa) should be >110°, with hysteresis between advancing and receding water contact angles (θa−θr)<10°.

In another example, the hydrophobic layers may be implemented using perfluorination of polymer surfaces by plasma-enhanced chemical vapor deposition (plasma-enhanced CVD). With respect to the plasma-enhanced CVD process, a direct spray or vacuum deposition process may be preferred. However, an inkjet process is possible. In this example, the hydrophobic layers are formed of a perfluorination compound (e.g., silane) deposited by PECVD. The final film thickness is about 10 nm to about 500 nm, preferably about 20 nm to about 200 nm. Further, the advancing water contact angle (θa) should be >105°, with hysteresis between advancing and receding water contact angles (θa−θr)<10°.

In yet another example, the hydrophobic layers may be implemented by a patterned laser ablation process (i.e., a physical roughening process) in combination with a deposition process, such as PECVD and/or plasma-enhanced CVD. In this example, the hydrophobic layers are a hydrophobic fluorosolvent-resistant finish. Further, the advancing water contact angle (θa) should be >110°, with hysteresis between advancing and receding water contact angles (θa−θr)<10°.

7.4 Systems

It will be appreciated that various aspects of the invention may be embodied as a method, system, computer readable medium, and/or computer program product. Aspects of the invention may take the form of hardware embodiments, software embodiments (including firmware, resident software, micro-code, etc.), or embodiments combining software and hardware aspects that may all generally be referred to herein as a “circuit,” “module” or “system.” Furthermore, the methods of the invention may take the form of a computer program product on a computer-usable storage medium having computer-usable program code embodied in the medium.

Any suitable computer usable medium may be utilized for software aspects of the invention. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the invention may be written in an object oriented programming language such as Java, Smalltalk, C++ or the like. However, the program code for carrying out operations of the invention may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The invention may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The invention may be applied to any wireless/wireline communications network, regardless of physical componentry, physical configuration, or communications standard(s).

Certain aspects of invention are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the invention.

### 8 CONCLUDING REMARKS

The foregoing detailed description of embodiments refers to the accompanying drawings, which illustrate specific embodiments of the invention. Other embodiments having different structures and operations do not depart from the scope of the present invention. The term “the invention” or the like is used with reference to certain specific examples of the many alternative aspects or embodiments of the applicants' invention set forth in this specification, and neither its use nor its absence is intended to limit the scope of the applicants' invention or the scope of the claims. This specification is divided into sections for the convenience of the reader only. Headings should not be construed as limiting of the scope of the invention. The definitions are intended as a part of the description of the invention. It will be understood that various details of the present invention may be changed without departing from the scope of the present invention. Furthermore, the foregoing description is for the purpose of illustration only, and not for the purpose of limitation.

We claim:

1. A method, comprising:
(a) measuring an impedance between a droplet operations electrode of a bottom substrate in a droplet actuator and ground electrode of a second substrate in the droplet actuator;
(b) storing a lookup table that associates impedances to heights of gaps between the first substrate and the second substrate;
(c) querying the lookup table for the impedance measured between the droplet operations electrode of the first substrate and the ground electrode of the second substrate; and
(d) retrieving a height of a gap associated with the impedance.

2. The method according to claim 1, further comprising retrieving a location of the droplet operations electrode in the droplet actuator.

3. The method according to claim 2, further comprising mapping the location of the droplet operations electrode and the height of the gap associated with the droplet operations electrode.

4. The method according to claim 2, further comprising mapping the location of the droplet operations electrode and the impedance associated with the droplet operations electrode.

5. The method according to claim 1, further comprising comparing the height of the gap to a specification.

6. The method according to claim 1, further comprising storing the impedances associated with all droplet operations electrodes in the droplet actuator.

7. A system, comprising:
(a) a processor;
(b) memory; and
(c) code stored in the memory that when executed causes the processor at least to:
(i) determine an impedance between a droplet operations electrode of a first substrate in a droplet actuator and ground electrode of a second substrate in the droplet actuator;
(ii) store a lookup table that associates impedances to heights of gaps between the first substrate and the second substrate;
(iii) query the lookup table for the impedance measured between the droplet operations electrode of the first substrate and the ground electrode of the second substrate; and
(iv) retrieve a height of a gap associated with the impedance.

8. The system according to claim 7, wherein the code further causes the processor to retrieve a location of the droplet operations electrode in the droplet actuator.

9. The system according to claim 8, wherein the code further causes the processor to map the location of the droplet operations electrode and the height of the gap associated with the droplet operations electrode.

10. The system according to claim 8, wherein the code further causes the processor to map the location of the droplet operations electrode and the impedance associated with the droplet operations electrode.

11. The system according to claim 7, wherein the code further causes the processor to compare the height of the gap to a specification.

12. The system according to claim 7, wherein the code further causes the processor to store the impedances associated with all droplet operations electrodes in the droplet actuator.
